(19) United States
(12) Patent Application Publication
(10) Pub. No.: US 2009/0061883 A1
(43) Pub. Date: Mar. 5, 2009

(54) Business reviews claiming in a geo-spatial environment

(75) Inventor: Raj Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/897,908

(22) Filed: Aug. 30, 2007

(51) Int. Cl. H04Q 7/20

(52) U.S. Cl. 455/445

(57) ABSTRACT

A method, system and apparatus of business reviews claiming in a geo-spatial environment are disclosed. In one embodiment, a method includes generating a community network of user profiles, each user profile to include an associated specific geographic location, at least a portion of the specific geographic locations associated with a business and/or a residence, associating a first user with a first user profile having a specific geographic location associated with a business, claiming the first user profile (e.g., may include verifying an email address, a business license, and/or a utility bill), and generating a promotion-related activity associated with the first user profile and the business.

### FIELD OF TECHNOLOGY

This disclosure relates generally to the technical fields of communications and, in one example embodiment, to a method, system and apparatus of business reviews claiming in a geo-spatial environment.

### BACKGROUND

Businesses may rely on advertising to promote related goods and/or services. The advertising may include offline promotion and/or online promotion. The offline promotion may include print advertisements, sponsorship of local events and teams, flyers, etc.

The offline promotion, however, may be ineffective. Print advertisements may not reach a target audience. Sponsorship activities may not rise to the attention of prospective customers. Flyers may have to be delivered door-to-door, a time-consuming process.

The online promotion may include business websites and customers reviews. Prospective customers, however, may not be aware of a business's website. The prospective customer may not want to search for individual business websites. The customer reviews may not cast the business in a favorable light, contrary to promotional goals of the business. A business owner may be unable to control unfavorable reviews, which may subject the business to unprofessional or biased motives of others.

### SUMMARY

A method, system and apparatus of business reviews claiming in a geo-spatial environment are disclosed. In one aspect, a method includes generating a community network of user profiles, each user profile to include an associated specific geographic location, a portion of the specific geographic locations associated with a business and/or a residence, associating a first user with a first user profile having a specific geographic location associated with the business, claiming the first user profile (e.g., may include verifying an email address, a business license, and/or a utility bill, etc.), and generating a promotion-related activity associated with the first user profile and the business.

The promotion-related activity may include selectively displaying at least one review associated with the business, permitting selective display of at least one review associated with the business upon a payment transaction, incorporating a website (e.g., may include a web page and/or a link associated with the business) associated with the business into the first user profile, generating an online transaction associated with the business, generating an advertisement associated with the first user profile, displaying the first user profile in conjunction with a wiki profile, generating content associated with the wiki profile, generating a poll associated with the business, generating a list of groups seeking sponsorship, and/or displaying the first user profile in conjunction with a list of groups sponsored by the business.

The online transaction may include reserving a product and/or a service associated with the business, ordering the product and/or the service associated with the business, and generating an online payment transaction associated with the business. The generating an advertisement may include displaying an online advertisement, generating a printed publication, generating a printed publication from the online advertisement, generating an advertisement based on a predetermined criterion associated with a second user profile, and generating a display view of the first user profile and the advertisement, the display view associated with the second user profile. The printed publication may include a coupon, a flyer and/or a post card.

In another aspect, a system includes a geographic community environment, a community network module of the geographic community environment to include user profiles, each user profile to include an associated specific geographic location, a portion of the specific geographic locations associated with a business and/or a residence, a map module of the geographic community environment to include map data which serve as a basis to render a three-dimensional map view which identifies at least some physical structures having specific geographic locations, and a claim module of the geographic community environment to claim a first user profile having a specific geographic location associated with a business.

The system also includes a display module of the geographic community environment to generate a display view of the three-dimensional map view embodied by the community network and the first user profile represented at a location in the three-dimensional map view associated with the specific geographic location of the first user profile, and a transaction module of the geographic community environment to generate a promotion-related activity associated with the first user profile and the business.

The claim module may further verify a proof of business ownership (e.g., may include an email address, a business license, and/or a utility bill). The system may further include a review control module of the geographic community environment to control the display of at least one review associated with the business. In addition, the system may include a payment module of the geographic community environment to permit selective control over display of the review associated with the business upon a payment transaction.

The system may also include a website module of the geographic community environment to incorporate a website (e.g., may include a display of a web page and/or a link associated with the business) associated with the business into the first user profile. In addition, the website module may include a reservation transaction to generate a reservation associated with a product and/or a service associated with the business, an order transaction to order the product and/or the service associated with the business, and/or an online payment transaction associated with the business.

The system may further include an advertisement module of the geographic community environment to generate an advertisement associated with the first user profile. The advertisement may include an online advertisement display, a printed publication, and/or a printed publication generated from the online advertisement. The printed publication may include may include a coupon, a flyer, and/or a post card. The advertisement module may also include an advertisement, based on a predetermined criterion associated with a second user profile, displayed in conjunction with the first user profile.

The system may also include a poll module of the geographic community environment to generate a poll associated with the business. In addition, the system may include a sponsorship module of the geographic community environment to generate a list of groups seeking sponsorship, and to display the first user profile in conjunction with a list of groups sponsored by the business. The system may also include a wiki profile module of the geographic community environment to generate in a display view, a wiki profile associated with a user profile and/or content associated with the wiki profile.

In yet another aspect, a geographic community environment includes a first instruction set to enable a community network, to include a user database to include user profiles, the community network associated with map data, in which the community network is associated with specific geographic locations identifiable in the map data and a portion of the specific geographic locations are associated with a business and/or a residence, a second instruction set integrated with the first instruction set to claim a user profile having a specific geographic location associated with a business, and a third instruction set integrated with the first instruction set and the second instruction set to generate a promotion-related activity associated with the user profile and the business.

In addition, the geographic community environment may include a fourth instruction set integrated with the first instruction set, the second instruction set and the third instruction set to selectively display in conjunction with the user profile at least one review associated with the business.

The methods and systems disclosed herein may be implemented in any means for achieving various aspects, and may be executed in a form of machine-readable medium embodying a set of instructions that, when executed by a machine, cause the machine to perform any of the operations disclosed herein. Other features will be apparent from the accompanying drawings and from the detailed descriptions that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a geographic community environment communicating with users through a network, according to one embodiment.

FIG. 2 is an exploded view of the community network module of FIG. 1, according to one embodiment.

FIG. 3 is an exploded view of the additional modules of FIG. 1, according to one embodiment.

FIG. 4 is a block diagram illustrating generation of a display view associated with reviews, according to one embodiment.

FIG. 5 is a user interface view displaying a homepage of a user profile associated with a business, according to one embodiment.

FIG. 6 is a user interface view of claiming the user profile associated with the business, according to one embodiment.

FIG. 7 is a user interface view displaying the reviews in the user profile associated with the business, according to one embodiment.

FIG. 8 is a user interface view of an online payment transaction associated with review control services, according to one embodiment.

FIG. 9 is a user interface view displaying a profile menu associated with the business, according to one embodiment.

FIG. 10 is a user interface view displaying a webpage associated with the business, according to one embodiment.

FIG. 11 is a user interface view of generating a poll associated with the business, according to one embodiment.

FIG. 12 is a user interface view displaying sponsorship details associated with the business, according to one embodiment.

FIG. 13 is a table view displaying information of user profiles associated with the users in the community network, according to one embodiment.

FIG. 14 is a diagrammatic system view of a data processing system in which any of the embodiments disclosed herein may be performed, according to one embodiment.

FIG. 15 is a process flow of generating a promotion-related activity associated with the business and the user profile, according to one embodiment.

Other features of the present embodiments will be apparent from the accompanying drawings and from the detailed description that follows.

### DETAILED DESCRIPTION

A method, system and apparatus of business reviews claiming in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

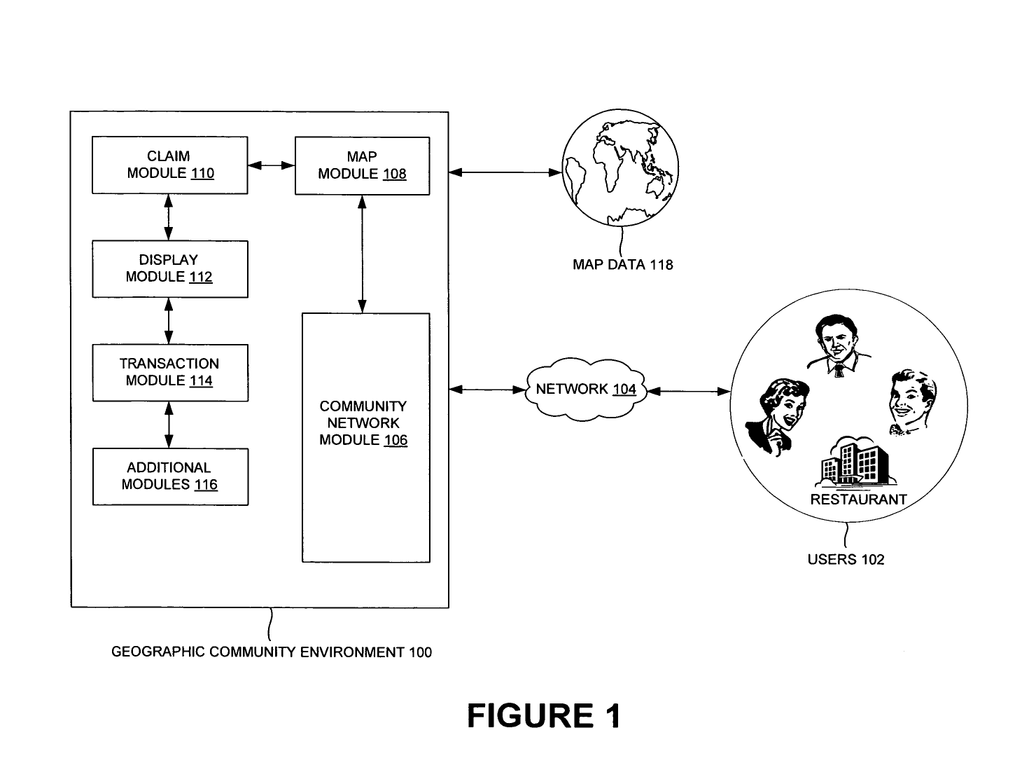

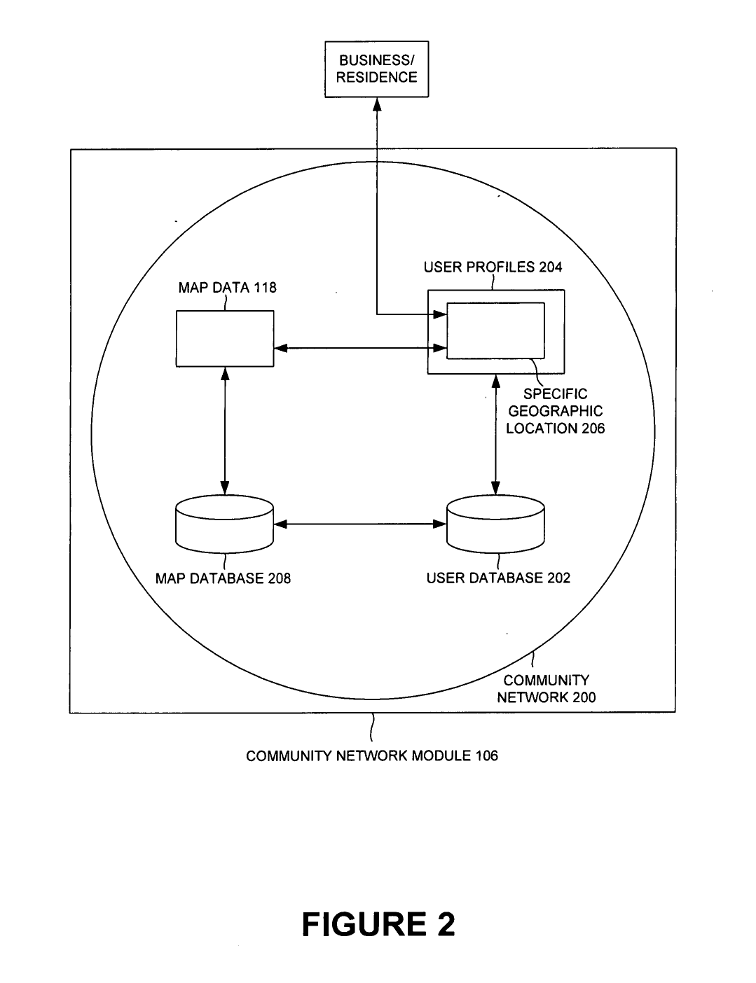

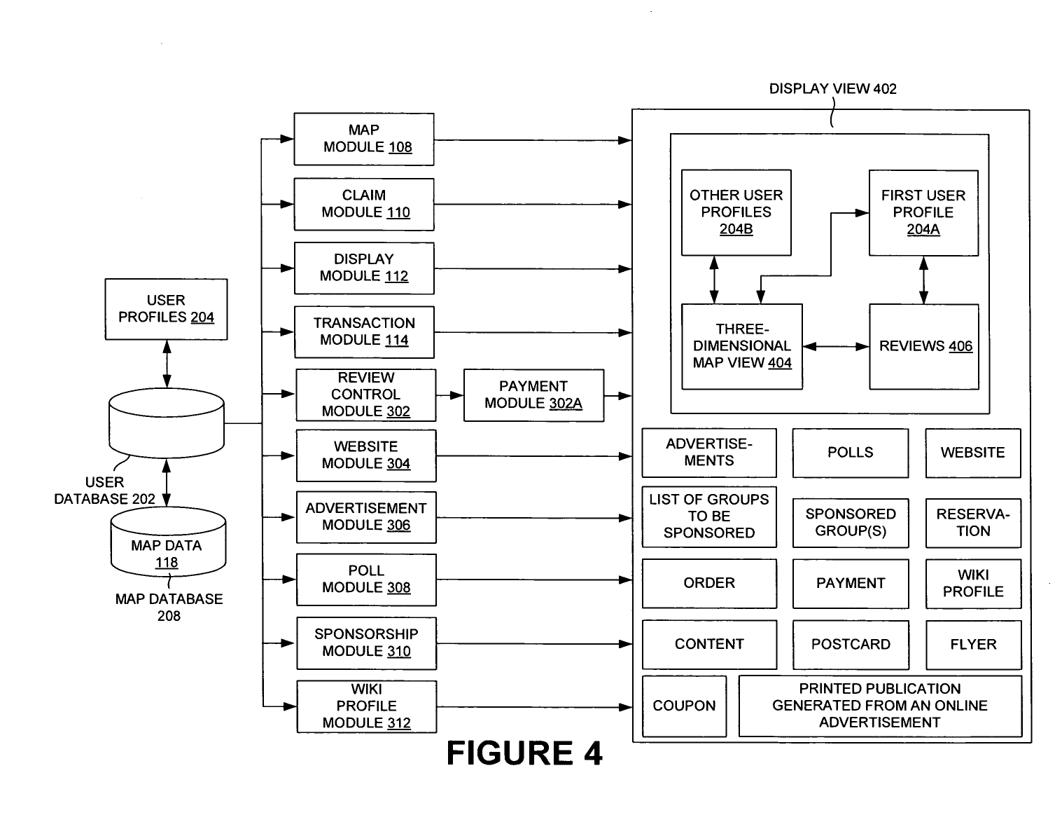

In one embodiment, a method includes generating a community network (e.g., the community network 200 of FIG. 2) of user profiles (e.g., the user profiles 204 of FIG. 2), each user profile 204 to include an associated specific geographic location (e.g., the specific geographic location 206 of FIG. 2), a portion of the specific geographic locations 206 associated with a business and/or a residence, associating a first user (e.g., of the users 102 of FIG. 1) with a first user profile (e.g., the first user profile 204A of FIG. 4) having a specific geographic location 206 associated with the business, claiming the first user profile 204A (e.g., may include verifying an email address, a business license, and/or a utility bill, etc.), and generating (e.g., using the transaction module 114 of FIG. 1) a promotion-related activity associated with the first user profile 204A and the business.

In another embodiment, a system includes a geographic community environment (e.g., the geographic community environment 100 of FIG. 1, a geo-spatial environment, etc.), a community network module (e.g., the community network module 106 of FIG. 1) of the geographic community environment 100 to include user profiles (e.g., the user profiles 204 of FIG. 2), each user profile 204 to include an associated specific geographic location (e.g., the specific geographic location 206 of FIG. 2), a portion of the specific geographic locations 206 associated with a business and/or a residence, and a map module (e.g., the map module 108 of FIG. 1) of the geographic community environment 100 to include map data (e.g., the map data 118 of FIG. 1) which serve as a basis to render a three-dimensional map view (e.g., the three-dimensional map view 404 of FIG. 4) which identifies physical structures having specific geographic locations 206.

The system also includes a claim module (e.g., the claim module 110 of FIG. 1) of the geographic community environment 100 to claim a first user profile (e.g., the first user profile 204A of FIG. 4) having a specific geographic location 206 associated with a business, a display module (e.g., the display module 112 of FIG. 1) of the geographic community environment 100 to generate a display view (e.g., the display view 402 of FIG. 4) of the three-dimensional map view 404 embodied by the community network 200 and the first user profile 204A represented at a location in the three-dimensional map view 404 associated with the specific geographic location 206 of the first user profile 204A, and a transaction module (e.g., the transaction module 114 of FIG. 4) of the geographic community environment 100 to generate a promotion-related activity associated with the first user profile 204A and the business.

In yet another embodiment, a geographic community environment (e.g., the geographic community environment 100 of FIG. 1) includes a first instruction set to enable a community network (e.g., the community network 200 of FIG. 2), to include a user database (e.g., the user database 202 of FIG. 2) to include user profiles (e.g., the user profiles 204 of FIG. 2), the community network 200 associated with map data (e.g., the map data 118 of FIG. 1), in which the community network 200 is associated with specific geographic locations 206 identifiable in the map data 118 and a portion of the specific geographic locations 206 associated with a business and/or a residence, a second instruction set integrated with the first instruction set to claim a user profile (e.g., of the user profiles 204 of FIG. 2) having a specific geographic location 206 associated with a business, and a third instruction set integrated with the first instruction set and the second instruction set to generate a promotion-related activity associated with the user profile 204 and the business.

FIG. 1 is a system view of a geographic community environment 100 communicating with users 102 through a network 104, according to one embodiment. Particularly, FIG. 1 illustrates the geographic community environment 100, the users 102, the network 104, a community network module 106, a map module 108, a claim module 110, a display module 112, a transaction module 114, additional modules 1 16 and map data 118, according to one embodiment.

The geographic community environment 100 may enable business reviews claiming associated with user profiles (e.g., the user profiles 204 of FIG. 2) in a community network (e.g., the community network 200 of FIG. 2). For example, the community network 200 may be formed by the users 102 in the geographic community environment 100 to interact and/or communicate with each other. The users 102 may be entities (e.g., individuals, businesses, residences, etc.) associated with the user profiles 204 of the community network 200 having specific geographic locations (e.g., the specific geographic location 206 of FIG. 2) in the geographic community environment 100. In one embodiment, the specific geographic location 206 is associated with business, residence, civic structure, etc.

The user profiles 204 may include name, address data, location data, reviews and/or web links of businesses associated with the specific geographic locations 206 in the geographic community environment 100. The network 104 may facilitate communication between the users 102 and the geographic community environment 100. The community network module 106 may generate the community network 200 that includes the user profiles 204 associated with the specific geographic location 206. For example, the users 102 of the geographic community environment 100 may form the community network 200 based on specific geographic locations 206 associated with a business and/or a residence.

The map module 108 may generate a three dimensional map view (e.g., the three-dimensional map view 404 of FIG. 4) which includes physical structures having the specific geographic location 206 in the geographic community environment 100. For example, the physical structures may include businesses, residences, and/or civic structures, etc. The claim module 110 may enable claiming of user profiles 204 having specific geographic locations 206 associated with businesses. In addition, the claim module 110 may verify a proof of business ownership. For example, the proof of business ownership may include an e-mail address, a business license, and/or a utility bill, etc. The display module 112 may generate a display view (e.g., the display view 402 of FIG. 4) of the three-dimensional map view 404 that visualizes user profiles 204, reviews 406, advertisements, reservations, poll 1104, sponsored groups 1204, and/or groups seeking sponsorship 1206 associated with the business in conjunction with representations of user profiles 504, wiki profiles 506, and/or content 508 associated with the wiki profiles 506. The transaction module 114 may generate promotion-related activities associated with the user profiles 204 and businesses.

The additional modules 116 may generate additional processes associated with the community network 200. For example, the additional processes may include generating advertisements, reviews, websites, list of groups seeking sponsorships, etc. associated with the business. The map data 118 may serve as a basis to generate the three-dimensional map view 404 in the geographic community environment 100.

In the example embodiment illustrated in FIG. 1, the geographic community environment 100 communicates with the users 102 through the network 104. The geographic community environment 100 includes the community network module 106, the map module 108, the claim module 110, the display module 112, the transaction module 114 and the additional modules 116, communicating with each other. In addition, the map module 108 processes (e.g., generates, tracks, captures, stores and/or analyzes, etc.) the map data 118.

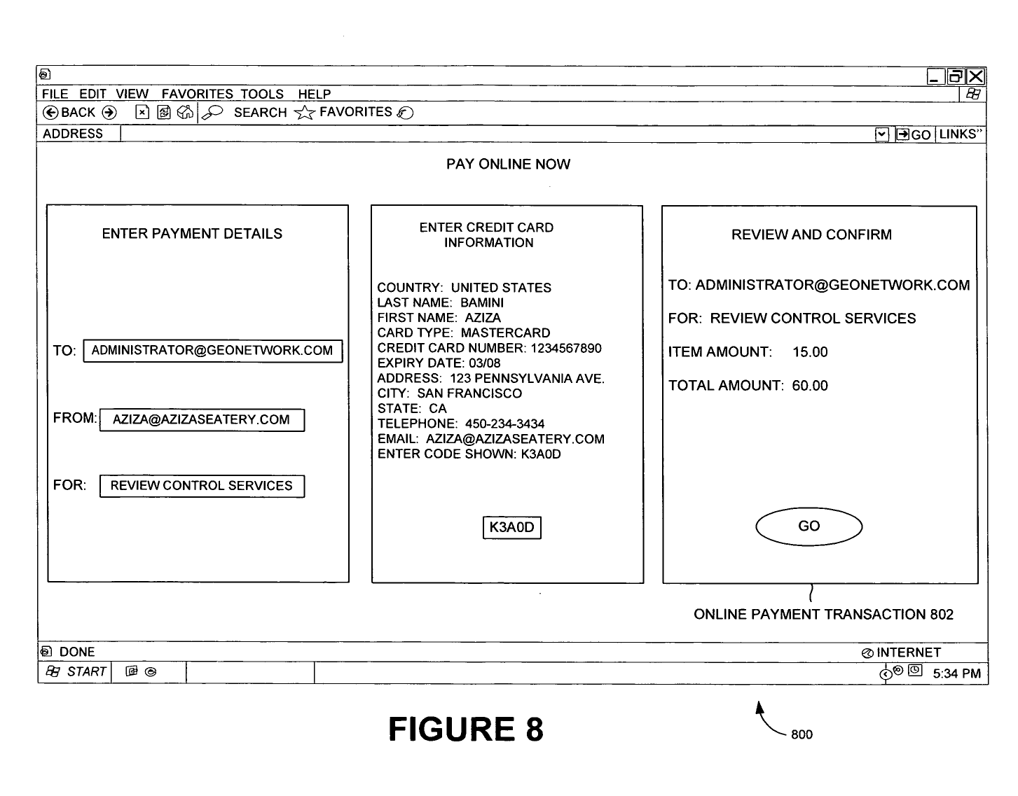

In one embodiment, a first user profile (e.g., the first user profile 204A of FIG. 4) may be claimed (e.g., through verification of an email address, a business license, and/or a utility bill, etc.). A promotion-related activity associated with the first user profile 204A and a business may be generated (e.g., using the transaction module 114 of FIG. 1). A review (e.g., the reviews 406 of FIG. 4) associated with the business may be selectively displayed. In one embodiment, the selective display of the review 406 associated with the business may be permitted upon a payment transaction (e.g., the online payment transaction 802 of FIG. 8). A website (e.g., may include a web page and/or a link) associated with the business may be incorporated into the first user profile 204A. An online transaction associated with the business may be generated.

In another embodiment, an advertisement associated with the first user profile 204A may be generated. In these embodiments, an online advertisement 1006 may be displayed. A printed publication may be generated and a printed publication from an online advertisement 1006 may be generated. For example, the printed publication may include a coupon, a flyer and/or a post card. An advertisement 1006 may be generated based on a predetermined criterion associated with a second user profile 204B. A display view (e.g., the display view 402 of FIG. 4) of the first user profile 204A may be generated and the advertisement, the display view 402 associated with the second user profile 204B.

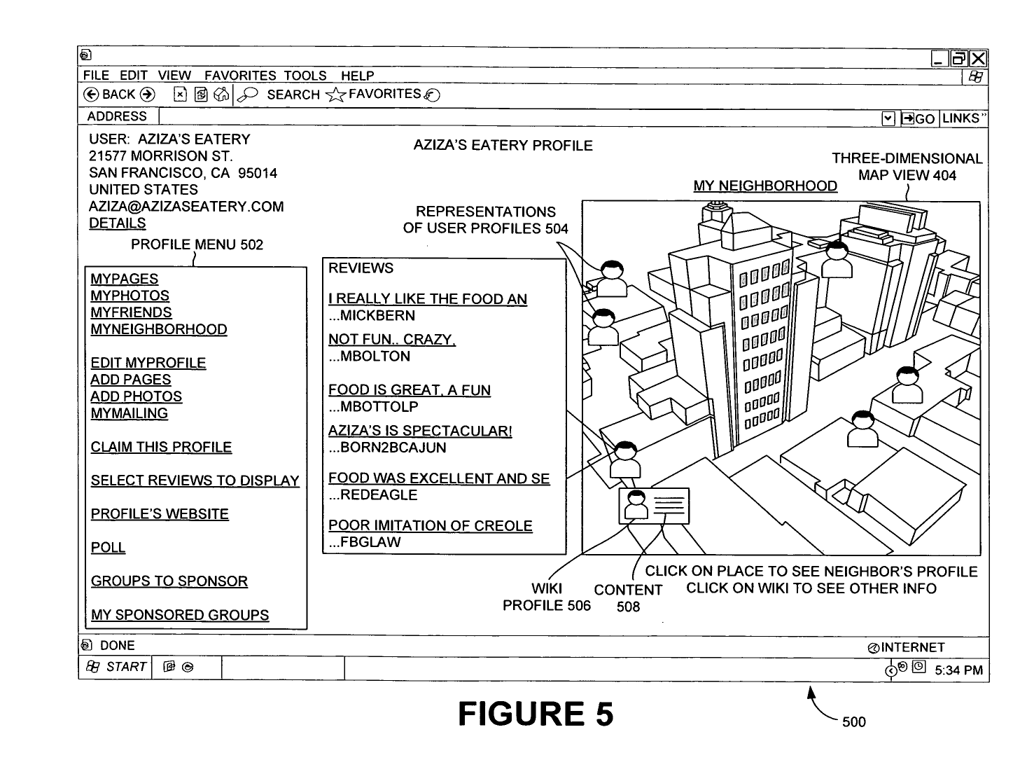

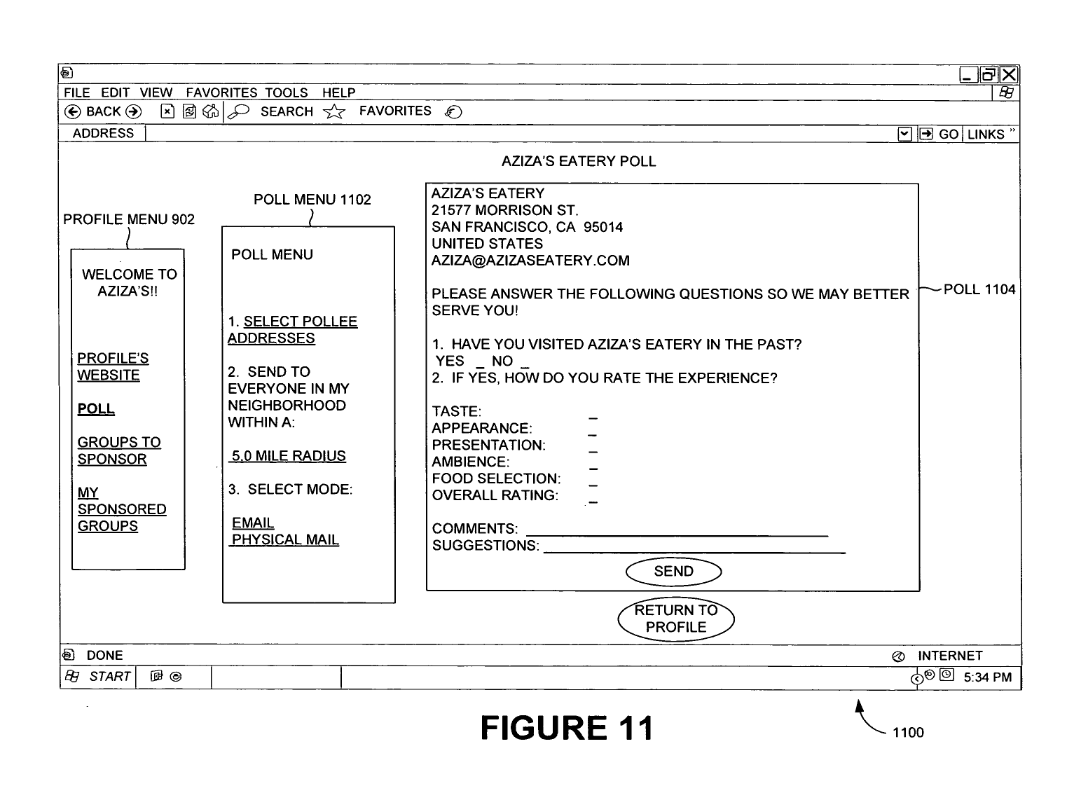

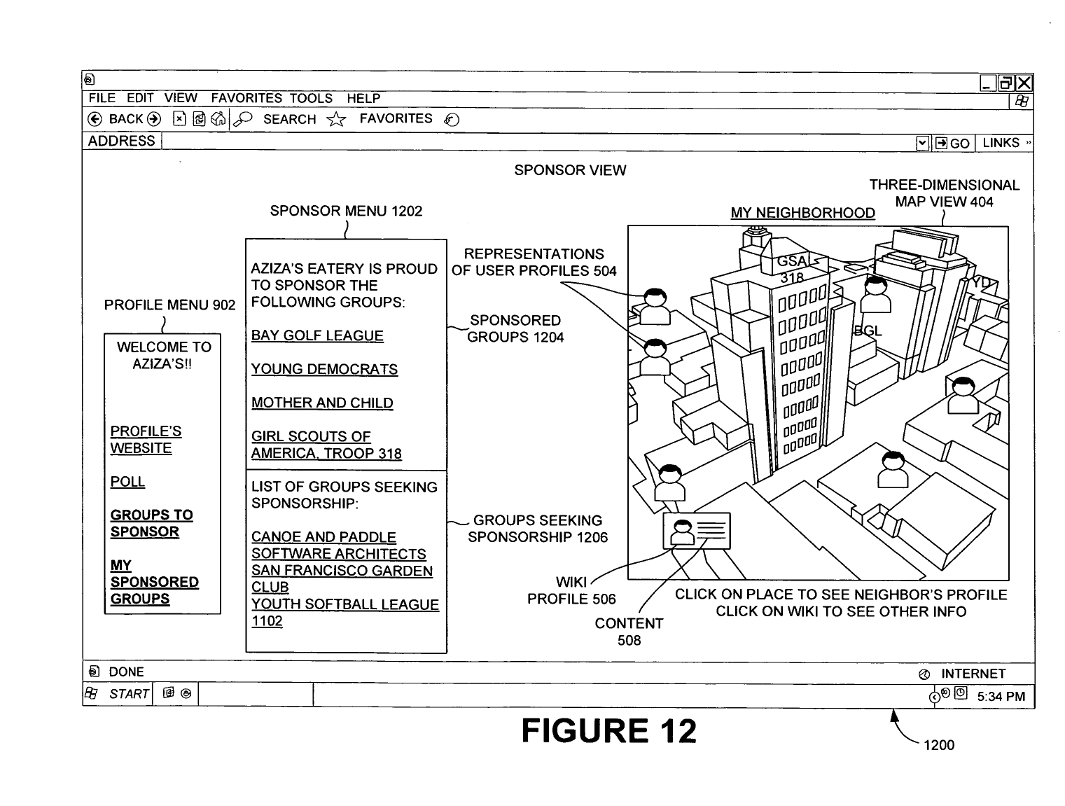

The first user profile 204A may be displayed in conjunction with a wiki profile (e.g., the wiki profile 506 of FIG. 5) and/or content (e.g., the content 508 of FIG. 5) associated with the wiki profile 506 may be generated. A poll (e.g., the poll 1104 of FIG. 11) associated with the business may be generated. A list of groups seeking sponsorship (e.g., the groups seeking sponsorship 1206 of FIG. 12) may be generated and the first user profile 204A may be displayed in conjunction with a list of groups (e.g., the sponsored groups 1204 of FIG. 12) sponsored by the business.

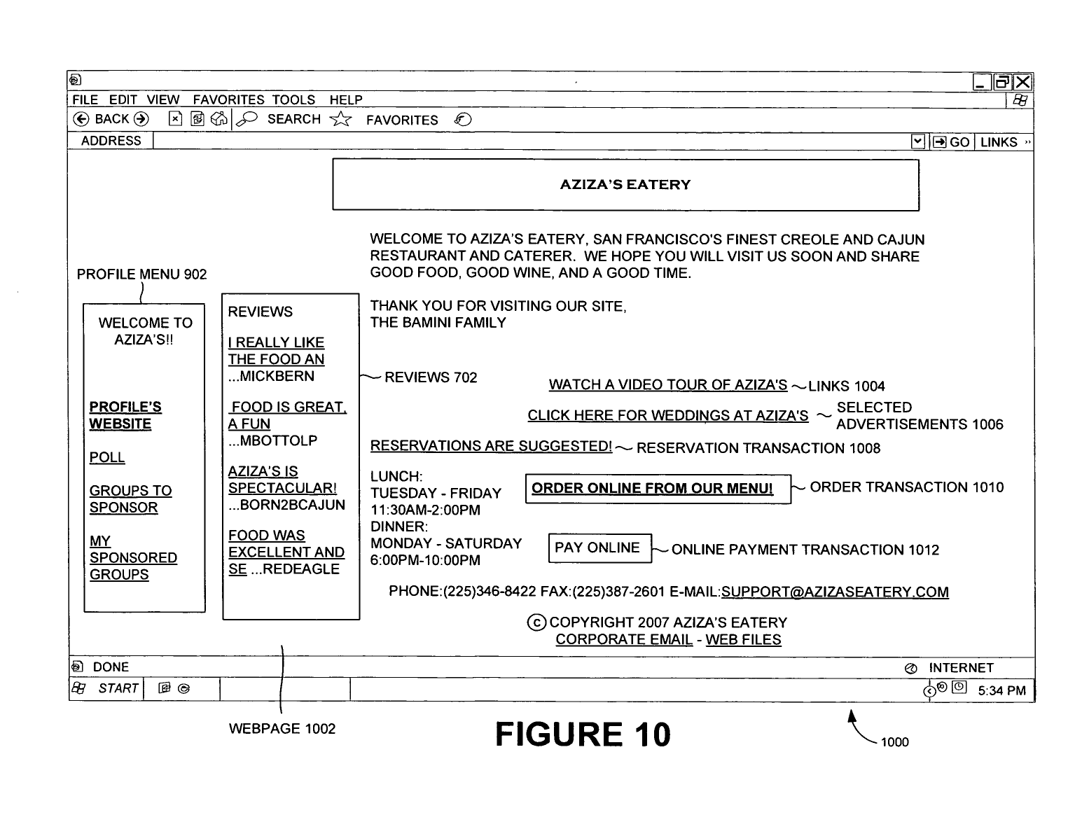

In additional embodiments, a product and/or a service associated with the business may be reserved. The product and/or the service associated with the business may be ordered. An online payment transaction (e.g., the online payment transaction 1012 of FIG. 10) associated with the business may be generated.

For example, the community network, module 106 of the geographic community environment 100 may include user profiles 204, each user profile 204 to include an associated specific geographic location 206, a portion of the specific geographic locations 206 associated with a business and/or a residence. The map module 108 of the geographic community environment 100 may include map data 118 which serve as a basis to render a three-dimensional map view 404 which identifies physical structures having specific geographic locations 206.

The claim module 110 of the geographic community environment 100 may claim the first user profile 204A having the specific geographic location 206 associated with the business. Further, the claim module 110 may verify a proof of business ownership (e.g., may include an email address, a business license, and/or a utility bill etc.). The display module 112 of the geographic community environment 100 may generate a display view 402 of the three-dimensional map view 404 embodied by the community network 200 and the first user profile 204A represented at a location in the three-dimensional map view 404 associated with the specific geographic location 206 of the first user profile 204A. The transaction module 114 of the geographic community environment 100 may generate the promotion-related activity associated with the first user profile 204A and the business.

In accordance with one or more embodiments, the geographic community environment 100 may include a first instruction set to enable the community network 200, may include a user database 202 to include user profiles 204, the community network 200 associated with map data 118, in which the community network 200 is associated with specific geographic locations 206 identifiable in the map data 118 and a portion of the specific geographic locations 206 associated with the business and/or the residence. The geographic community environment 100 may also include a second instruction set integrated with the first instruction set to claim the user profile 204 having a specific geographic location 206 associated with the business, and a third instruction set integrated with the first instruction set and the second instruction set to generate the promotion-related activity associated with the user profile 204 and the business. In addition, the geographic community environment I 00 includes a fourth instruction set integrated with the first instruction set, the second instruction set and the third instruction set to selectively display in conjunction with the user profile 204, review 406 associated with the business.

FIG. 2 is an exploded view of the community network module 106 of FIG. 1, according to one embodiment. Particularly, FIG. 2 illustrates the map data 118, a community network 200, a user database 202, user profiles 204, a specific geographic location 206 and a map database 208, according to one embodiment.

The community network 200 may enable promotion-related activities associated with the business in the geographic community environment 100. The user database 202 may generate the user profiles 204 associated with the community network 200. The user profiles 204 may be profiles associated with businesses, generated from the user database 202 of the geographic community environment 100. The specific geographic location 206 may be a geographical location associated with the user profiles 204 and the business in the geographic community environment 100. For example, the geographical location associated with the user profiles 204 may be identified based on latitude, longitude, and/or an altitude. The map database 208 may generate map data 11 8 (e.g., address data and/or location data, etc.) that serve as the basis to render the three-dimensional map view 404.

In the example embodiment illustrated in FIG. 2, the community network 200 includes the map data 118, the user database 202, the user profiles 204, the specific geographic location 206 and the map database 208, communicating with each other.

In one embodiment, the community network 200 of the user profiles 204 may be generated, each user profile 204 to include an associated specific geographic location, a portion of the specific geographic locations 206 associated with a business and/or a residence. A first user 102 may be associated with a first user profile 204A having the specific geographic location 206 associated with the business.

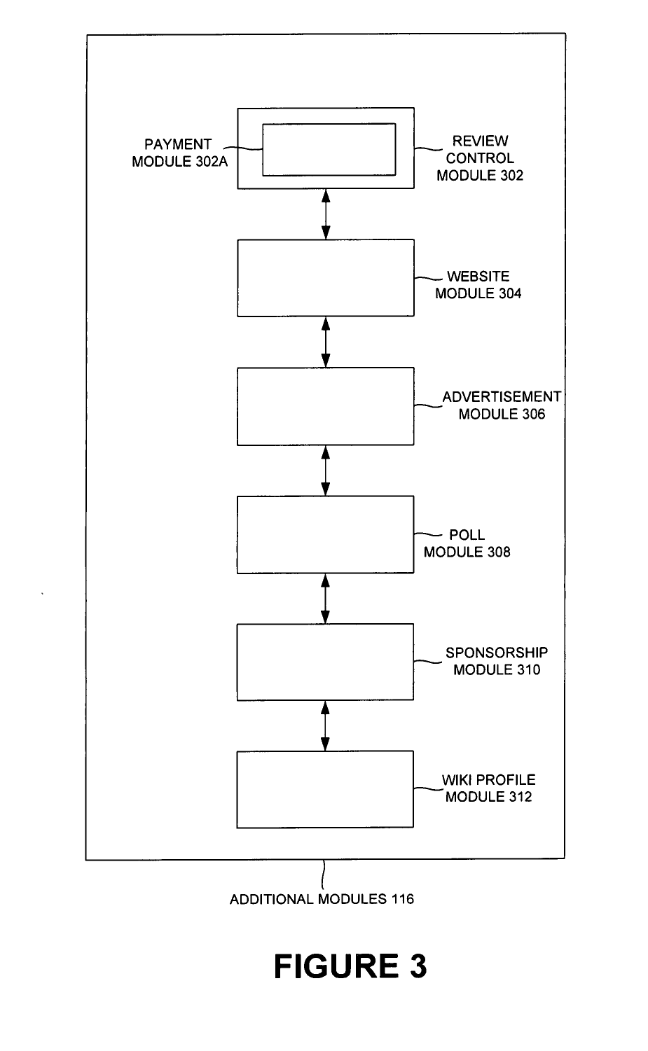

FIG. 3 is an exploded view of the additional modules 116 of FIG. 1, according to one embodiment. Particularly, FIG. 3 illustrates a review control module 302, a payment module 302A, a website module 304, an advertisement module 306, a poll module 308, a sponsorship module 310 and a wiki profile module 312, according to one embodiment.

The review control module 302 may control display of reviews associated with a business. The payment module 302A may permit selective control over display of the reviews associated with the business upon a payment transaction. The website module 304 may incorporate a website associated with the business into user profile 204. For example, the website may include a display of a web page (e.g., the webpage 1002 of FIG. 10) and/or a link (e.g., the links 1004 of FIG. 10) associated with the business. Further, the website module 304 may include a reservation transaction (e.g., the reservation transaction 1008 of FIG. 10) to generate a reservation associated with a product and/or a service associated with the business, an order transaction (e.g., the order transaction 1010 of FIG. 10) to order the product and/or the service associated with the business and/or an online payment transaction (e.g., the online payment transaction 1012 of FIG. 10) associated with the business.

The advertisement module 306 may generate an advertisement (e.g., the selected advertisements 1006 of FIG. 10) associated with a user profile 204. In one embodiment, the user profile 204 is associated with the business. The poll module 308 may generate a poll (e.g., the poll 1104 of FIG. 11) associated with the business. For example, the poll 1104 may be a survey of public opinion of the business. The sponsorship module 310 may generate a list of groups seeking sponsorship. For example, the groups may include golf leagues, softball leagues, baseball leagues, basketball leagues, etc. Further, the sponsorship module 310 may display the user profile 204 associated with the business in conjunction with a list of groups sponsored by the business. The wiki profile module 312 may generate wiki profiles (e.g., the wiki profile 506 of FIG. 5) associated with the user profiles 204 and content associated with the wiki profile 506.

In the example embodiment illustrated in FIG. 3, the additional modules include the review control module 302, the payment module 302A, the website module 304, the advertisement module 306, the poll module 308, the sponsorship module 310 and the wiki profile module 312, communicating with each other.

FIG. 4 is a block diagram illustrating generation of a display view 402 associated with reviews 406, according to one embodiment. Particularly, FIG. 4 illustrates the map module 108, the claim module 110, the display module 112, the transaction module 114, the map data 118, the user database 202, the user profiles 204, a first user profile 204A, other user profiles 204B, the map database 208, the review control module 302, the payment module 302A, the website module 304, the advertisement module 306, the poll module 308, the sponsorship module 310, the wiki profile module 312, the display view 402, a three-dimensional map view 404 and the reviews 406, according to one embodiment.

The display view 402 may display the user profiles 204, advertisements, selected reviews 406, poll 1104, list of sponsored groups 1204 and/or websites associated with the business on the three-dimensional map view 404. The three-dimensional map view 404 may enable visualization of the user profiles 204 and the selected reviews 406 associated with the business in conjunction with wiki profiles 506 and representations of user profiles 504. The reviews 406 may include opinions, analyses, evaluations and/or comments about the business. For example, business reviews may be intended for promotional goals of the business. In one embodiment, the user 102 may be permitted to selectively display the reviews 406 associated with the business.

In the example embodiment illustrated in FIG. 4, the display view 402 includes the three-dimensional map view 404 and the reviews 406. The display view 402 also displays the first user profile 204A and the other user profiles 204B generated from the user database 202. The reviews 406, advertisements, websites, poll 1104, coupons, postcard, flyers, publication, and/or sponsored groups, etc. associated with the business are also displayed in the display view 402.

In one embodiment, the review control module 302 of the geographic community environment 100 may control display of the review 406 associated with the business. The payment module 302A of the geographic community environment 100 may permit selective control over display of the review 406 associated with the business upon the payment transaction 802. The website module 304 of the geographic community environment 100 may incorporate a website associated with the business into the first user profile 204A.

The advertisement module 306 of the geographic community environment 100 may generate the advertisement 1006 associated with the first user profile 204A. For example, the advertisement may include an online advertisement display, a printed publication, and/or a printed publication generated from the online advertisement 1006. For example, the printed publication may include a coupon, a flyer and/or a post card. In addition, the advertisement module 306 may include an advertisement 1006 based on a predetermined criterion associated with a second user profile 204B, displayed in conjunction with the first user profile 204A. The poll module 308 of the geographic community environment 100 may generate the poll 1104 associated with the business.

The sponsorship module 310 of the geographic community environment 100 may generate the groups seeking sponsorship 1206 and display the first user profile 204A in conjunction with a list of groups sponsored by the business 1204. The wiki profile module 312 of the geographic community environment 100 may generate in the display view 402, the wiki profile 506 associated with the user profile 204 and the content 508 associated with the wiki profile 506.

FIG. 5 is a user interface view 500 displaying a homepage of a user profile 204 associated with a business, according to one embodiment. Particularly, FIG. 5 illustrates the three-dimensional map view 404, a profile menu 502, representations of user profiles 504, a wiki profile 506 and content 508, according to one embodiment.

The profile menu 502 may enable claiming of the user profile 204 (e.g., Aziza's Eatery profile) associated with the home page. In one embodiment, claiming the user profile 204 through the profile menu 502 may include verifying an email address, a business license, and/or a utility bill, etc. In addition, the profile menu 502 may enable a promotion-related activity associated with the user profile 204 of the business.

The profile menu 502 may permit selective display of a review(s) 406 associated with the business. In one embodiment, the selective display of the review(s) 406 in the three-dimensional map view 404 is permitted upon a payment transaction. The profile menu 502 may display profile information associated with the user profile 204 and enable a user (e.g., of the users 102 of FIG. 1) to edit, modify, create, add and/or delete information displayed in the user profile 204 associated with the business. For example, the profile information may include a business name, address data, an email address, and/or content associated with a website (e.g., associated with the business) incorporated in the user profile 204.

In the example embodiment illustrated in FIG. 5, the user interface view 500 displays the profile menu 502 and the three-dimensional map view 404. The user interface view 500 displays a mypages link, a myphotos link, a myfriends link, a myneighborhood link, a add pages link, a add photos link, a mymailing link, a poll link, a groups to sponsor link, a my sponsored groups link in the profile menu 502. The edit my profile link in the profile menu 502 may enable an owner of Aziza's Eatery to edit information associated with the business. The owner can also claim the Aziza's Eatery profile through a claim this profile link displayed in the profile menu 502 of the user interface view 500.

In addition, the owner can select a review(s) 702 associated with Aziza's Eatery to be displayed in the three-dimensional map view 404 through select reviews to display link in the profile menu 502. The three-dimensional map view 404 displays the wiki profiles 506, the content 508 associated with the wiki profile 506 and the representations of user profiles 504 in conjunction with the Aziza's Eatery profile.

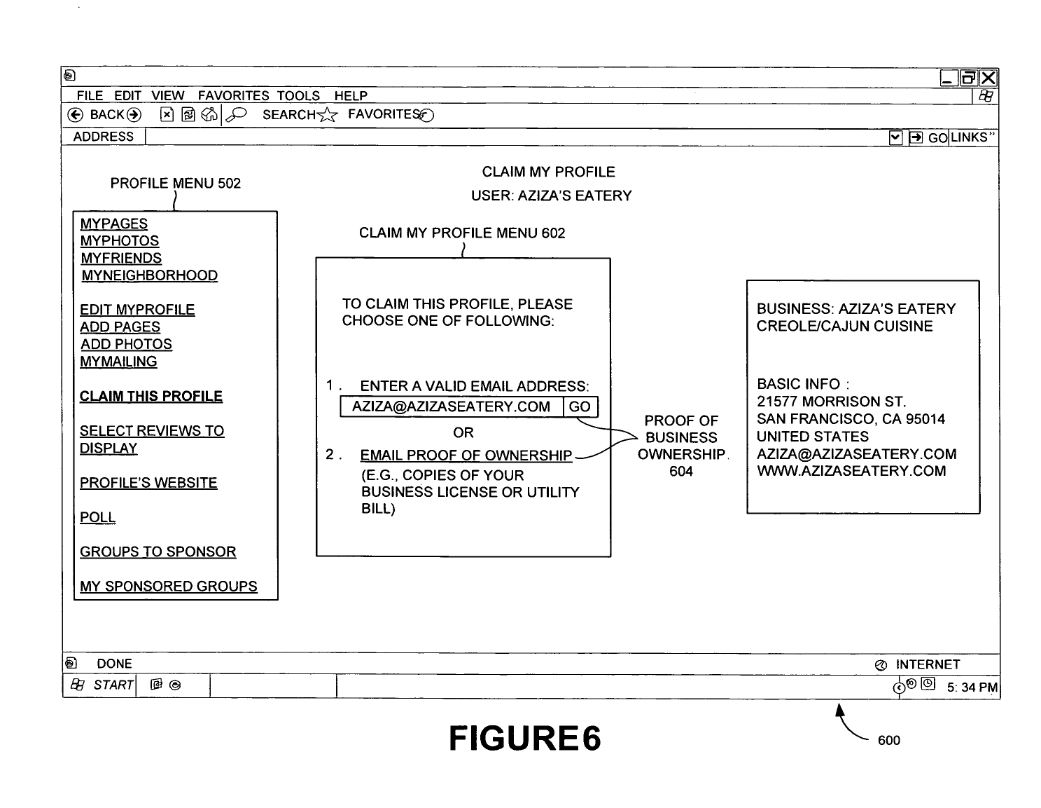

FIG. 6 is a user interface view 600 of claiming the user profile 204 associated with the business, according to one embodiment. Particularly, FIG. 6 illustrates the profile menu 502, a claim my profile menu 602 and a proof of business ownership field 604, according to one embodiment.

The claim my profile menu 602 may enable the user 102 (e.g., Aziza's Eatery) to claim the user profile 204 having a specific geographic location 206 associated with the business. The proof of business ownership field 604 may enable the user 102 to submit a valid email address, a copy of business license, and/or utility bill associated with the business. In one embodiment, the user profile 204 associated with the business can be claimed upon submission and verification of a proof of business ownership.

In the example embodiment illustrated in FIG. 6, the user interface view 600 may enable the owner of Aziza's Eatery to claim the Aziza's Eatery profile located at 21577 Morrison St. San Francisco, Calif. 95014. For example, the owner of Aziza's Eatery may claim the Aziza's Eatery profile by providing various proofs of business ownership such as email address, copies of business license, utility bill, etc. In the example embodiment illustrated in FIG. 6, the owner of Aziza's Eatery provides the proof of business ownership as aziza@azizaseatery.com through the enter a valid email address field to claim the Aziza's Eatery profile.

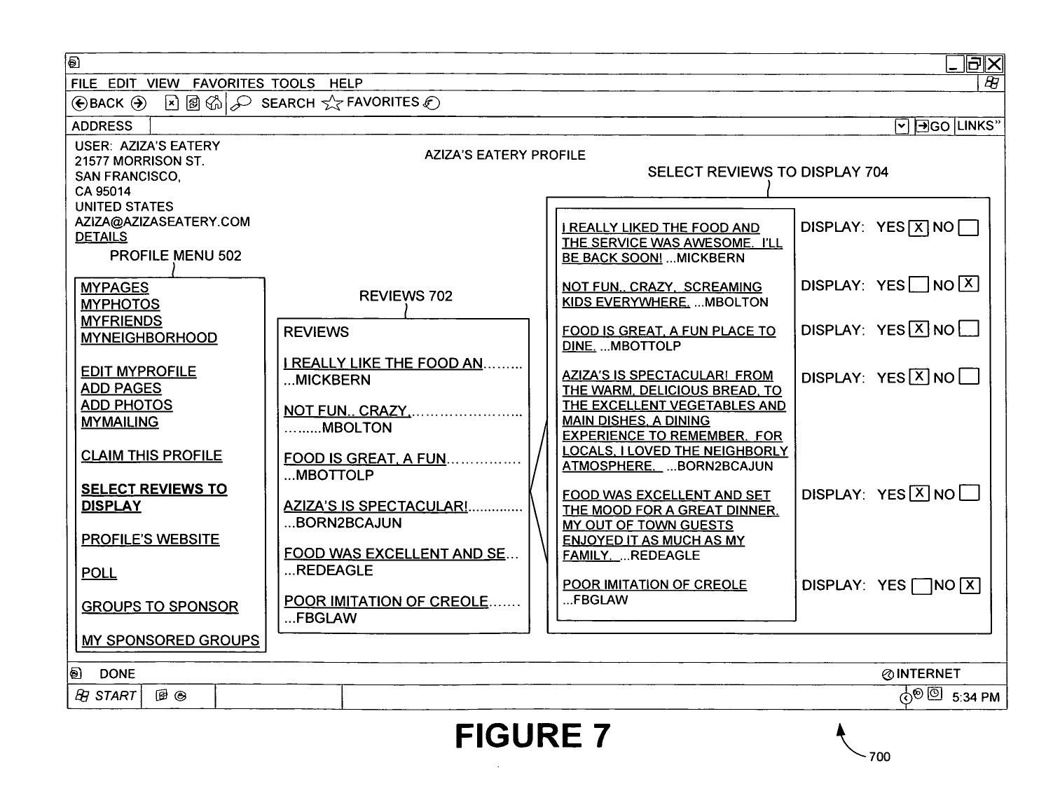

FIG. 7 is a user interface view 700 displaying the reviews 406 in the user profile 204 associated with the business, according to one embodiment. Particularly, FIG. 7 illustrates the profile menu 502, a reviews block 702, and a select reviews to display option 704, according to one embodiment.

The reviews block 702 may display a review(s) associated with the business. For example, the review(s) 406 may be an evaluation about the business that provides products and/or services. The select reviews to display option 704 may enable the user 102 associated with the business to select favorable reviews 406 (e.g., associated with the business) to be displayed. In one embodiment, the selected review(s) 406 associated with the business is displayed upon payment transaction.

In the example embodiment illustrated in FIG. 7, the user interface view 700 may enable the owner of Aziza's Eatery to select the reviews 406 (e.g., favorable reviews) to be displayed to the public for promoting the business through the select reviews to display option 704. In one example embodiment, the owner of Aziza's Eatery may be enabled to select the reviews 406 associated with Aziza's Eatery to be displayed in the website through check box (e.g., checking Yes or No option) corresponding to each review.

FIG. 8 is a user interface view 800 of an online payment transaction 802 associated with review control services, according to one embodiment. Particularly, FIG. 8 illustrates the online payment transaction 802, according to one embodiment.

The online payment transaction 802 may be an online transaction associated with the review control services to be availed to a particular business associated with the user profile 204. In one embodiment, the online payment transaction 802 may be carried out by providing a valid email address of a payee and the business to which the review control services will be availed, credit card info, entering code (e.g., for security purposes) and confirming payment details.

In the example embodiment illustrated in FIG. 8, the user interface view 800 displays a payment details block, a credit card information block, a review and confirm block, etc. The payment details block displays a sender field (e.g., aziza@azizaseatery.com), a payee field (e.g., administrator@geonetwork.com) and a services availed field (e.g., Review control services). The credit card information block displayed in the user interface view 700 is structured into fields such as country, last name, first name, card type, credit card number, expiry date, address, city, state, telephone, email address, code, etc. The review and confirm block displays the payment info provided by the owner of Aziza's Eatery in the payment details and the credit card info block prior to making the payment.

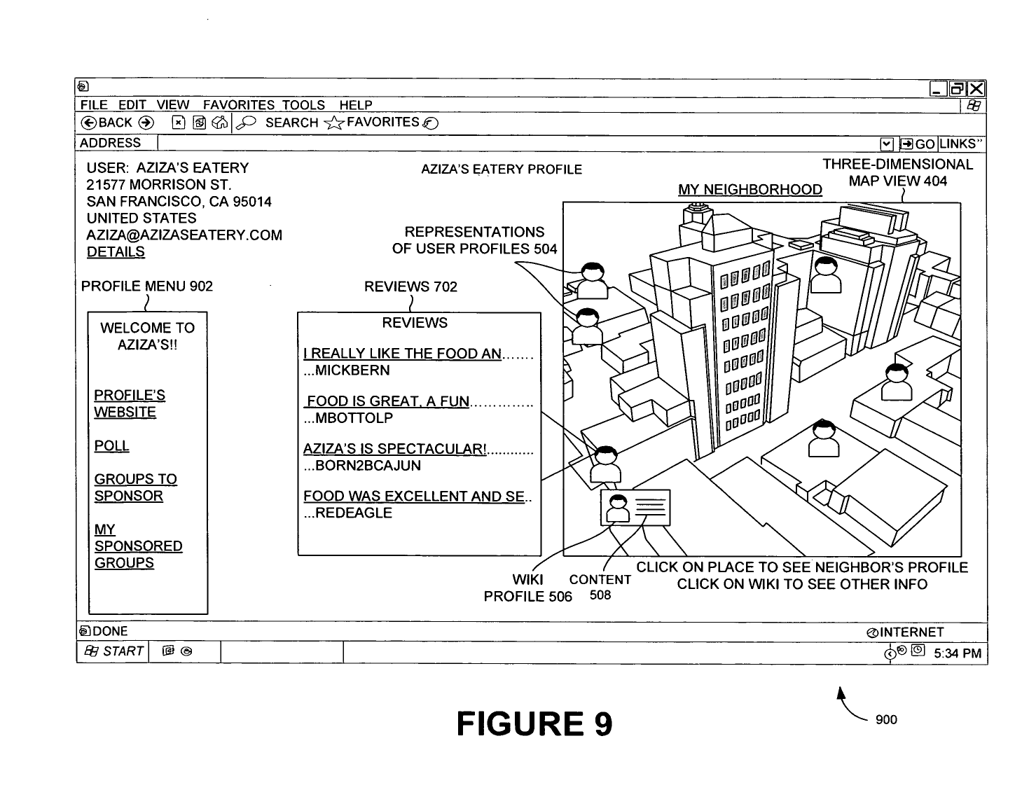

FIG. 9 is a user interface view 900 displaying a profile menu 902 associated with the business, according to one embodiment. Particularly, FIG. 9 illustrates the three-dimensional map view 404, the representations of user profiles 504, the wiki profiles 506, the content 508, the reviews block 702 and a profile menu 902, according to one embodiment.

The profile menu 902 may enable visualization of a profile's website, a poll, groups to sponsor and groups sponsored by the business to other users 102 of the community network 200.

In the example embodiment illustrated in FIG. 9, the user interface view 900 displays the profile menu 902, selected reviews 406 and location of the Aziza's Eatery in the three-dimensional map view 404. The user interface view 900 may enable other users 102 to visualize the reviews 406 selected for display by the owner of Aziza's Eatery. In addition, other users 102 can view Aziza's Eatery's website, a poll associated with Aziza's Eatery, sponsored groups by Aziza's Eatery and groups to sponsor through a profile website link, a poll link, a my sponsored groups link and a groups to sponsor link displayed in the profile menu 902 respectively. The three-dimensional map view 404 displays the Aziza's Eatery profile in conjunction with the wiki profile 506, the content 508 associated with the wiki profile 506 and the representations of user profiles 504.

FIG. 10 is a user interface view 1000 displaying a webpage 1002 associated with the business, according to one embodiment. Particularly, FIG. 10 illustrates the reviews block 702, the profile menu 902, the webpage 1002, links 1004, selected advertisements 1006, a reservation transaction 1008, an order transaction 1010 and an online payment transaction 1012, according to one embodiment.

The webpage 1002 may be a document accessible by the users 102 containing information associated with the business. For example, the webpage 1002 may display profile details, links 1004, selected advertisements 1006, online payment transaction 1012, etc. associated with the business. The links 1004 may be references to other documents associated with the business. The selected advertisements 1006 may include advertisements selected by the business to be displayed on the webpage 1002.

The reservation transaction 1008 may generate reservations of products and/or services associated with the business. The order transaction 1010 may order the products and/or the services associated with the business. The online payment transaction 1012 may generate online payments associated with the business.

In the example embodiment illustrated in FIG. 10, the user interface view 1000 displays the webpage 1002 associated with Aziza's Eatery. The webpage 1002 displays a welcome note, reviews 406, the links 1004, the selected advertisements 1006, etc. associated with Aziza's Eatery. The links 1004 may provide a reference to a video tour of Aziza's Eatery. The users 102 may visualize Aziza's Eatery's menu, reserve desired menu and order the menu by paying online. The reviews 406 cast Aziza's Eatery in a favorable light and the users 102 may physically visit Aziza's Eatery by viewing and analyzing the webpage 1002.

FIG. 11 is a user interface view 1100 of generating a poll 1104 associated with the business, according to one embodiment. Particularly, FIG. 11 illustrates the profile menu 902, a poll menu 1102 and the poll 1104, according to one embodiment.

The poll menu 1102 may enable a user(s) 102 of the community network 200 to communicate the poll 1104 to people located within a threshold distance.via a communication mode such as email, physical mail, etc. The poll 1104 may display a set of questions regarding the business. For example, the set of questions may include quality of the product and/or service, appearance, presentation, ambience, taste, overall ratings, etc. associated with the business. In addition, the poll 1104 may enable the users 102 to post comments and/or suggestions that help the business to improve standard of product and/or service.

In the example embodiment illustrated in FIG. 11, the user interface view 1100 displays the profile menu 902, the poll menu 1102 and the poll 1104. The user interface view 1100 displays the poll 1104 associated with Aziza's Eatery upon selecting the poll link in the profile menu 902. The poll menu 1102 displays a select pollee addresses option that may enable the user 102 to select the addresses of people in a neighborhood to whom the user 102 may wish to send the poll 1104. The user 102 may send the poll 1104 to the intended recipients within a radius of 5 miles from Aziza's Eatery, 21577 Morrison St. San Francisco, Calif. 95014 through an email and/or a physical mail, according to example embodiment illustrated in FIG. 11.

The poll 1104 displays location and email address of Aziza's Eatery as 21577 Morrison St. San Francisco, Calif. 95014 and aziza@azizaeatery.com respectively. The poll 1104 may also display a question (e.g., ‘Have you visited Aziza's Eatery in the past?’), querying the users 102 regarding their experience with Aziza's Eatery. If the pollees have previously visited Aziza's Eatery, then the pollees may be further queried about taste, appearance, presentation, ambience, food selection and/or overall ratings associated with the food in Aziza's Eatery. Further, the users 102 may also provide feedback and/or suggestions (e.g., in response to the poll 1104) to improve the quality and/or services of food served by Aziza's Eatery.

FIG. 12 is a user interface view 1200 displaying sponsorship details associated with business, according to one embodiment. Particularly, FIG. 12 illustrates the three-dimensional map view 404, the representations of user profiles 504, the wiki profile 506, the content 508, the profile menu 902, a sponsor menu 1202, sponsored groups 1204 and groups seeking sponsorship 1206, according to one embodiment.

The sponsor menu 1202 may display a list groups sponsored by the business and a list of groups seeking sponsorship from the business. The sponsored groups 1204 may be groups that are assured, financed and/or guaranteed by the business. For example, the business may offer sponsorship to support an event, activity, person and/or organization by providing money and/or other resources intended for advertising and/or publicity. The groups seeking sponsorship 1206 may represent the list of groups looking for sponsorship from the business.

In the example embodiment illustrated in FIG. 12, the user interface view 1200 displays the sponsored groups 1204 and the groups seeking sponsorship 1206 associated with the business Aziza's Eatery. The sponsored groups 1204 include Bay Golf League, Young Democrats, Mother and Child, and Girl Scouts of America, Troop 318, which are sponsored by Aziza's Eatery. The groups seeking sponsorship 1206 includes Canoe and Paddle, Software Architects, San Francisco Garden Club and Youth Softball League 1102, which are looking for sponsorship from Aziza's Eatery.

Further, the user interface view 1200 also displays the representations of user profiles 504, the wiki profile 506 and the content 508 associated with the wiki profile 506 in conjunction with the sponsored groups 1204 on the three-dimensional map view 404. The user interface view 1200 also allows the users to view the groups associated with Aziza's Eatery through the click on place to see group's profile option.

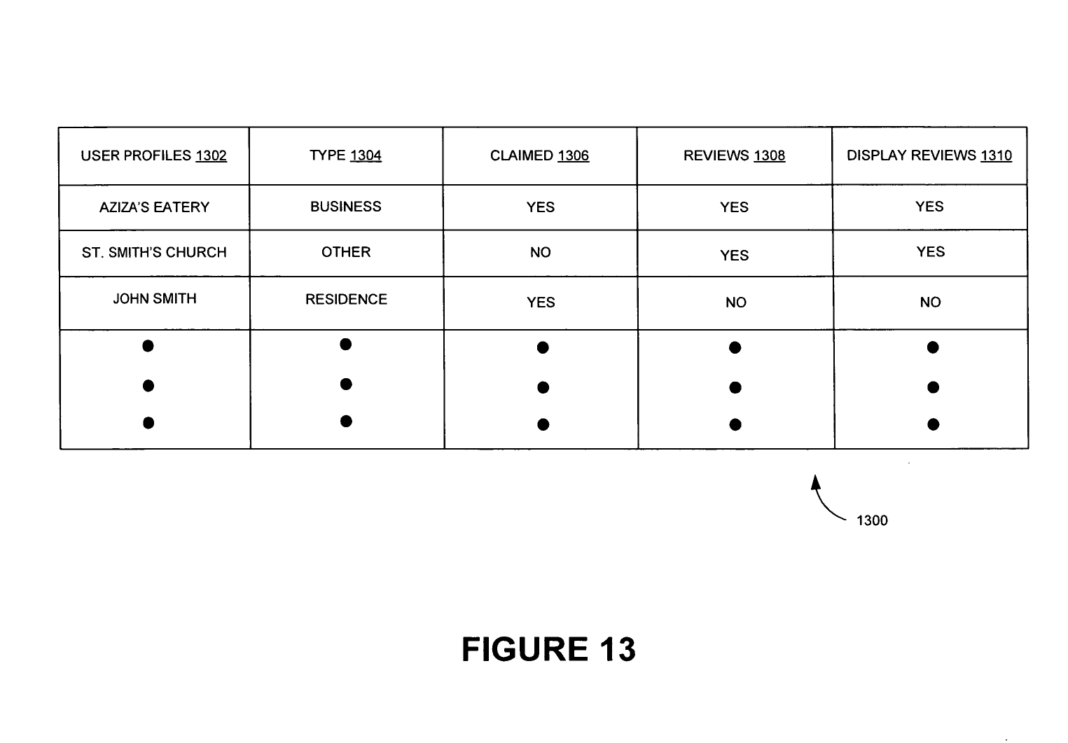

FIG. 13 is a table view 1300 displaying information of user profiles 204 associated with users 102 in the community network 200, according to one embodiment. Particularly, FIG. 13 illustrates a user profiles field 1302, a type field 1304, a claimed field 1306, a reviews field 1308 and a display reviews field 1310, according to one embodiment.

The user profiles field 1302 may display an identifier (e.g., a name, a username, a unique key, etc.) associated with the users 102 of the geographic community environment 100. The type field 1304 may indicate type of the user profiles 204 in the community network 200. For example, the type may include residence, business, etc. associated with the user profiles 204. The claimed field 1306 may indicate whether or not the user profile 204 is claimed. The reviews field 1308 may indicate whether or not reviews are associated with the business and the user profiles 204. The display reviews field 1310 may indicate whether or not the reviews are selected for display in the geographic community environment 100.

In the example embodiment illustrated in FIG. 13, the user profiles field 1302 displays ‘Aziza's Eatery’ in the first row, ‘St. Smith's Church’ in the second row and ‘John Smith’ in the third row of the user profiles field column 1302. The type field displays ‘business’ in the first row, ‘other ‘in the second row and ‘residence’ in the third row of the type field column 1304 (e.g., Aziza's Eatery's profile is associated with business, John Smith's profile is associated with residence while St. Smith Church's profiles comes under the category ‘other’). The claimed field 1306 displays ‘Yes’ in the first row, ‘No’ in the second row and ‘Yes’ in the third row of the claimed field column 1306 (e.g., the profiles associated with Aziza Eatery and John Smith are claimed while the profile associated with St. Smith Church is not claimed).

The reviews field 1308 displays ‘Yes’ in the first row, ‘Yes’ in the second row and ‘No’ in the third row of the reviews field column 1308 (e.g., there are reviews associated with Aziza Eatery's profile and St. Smith Church's profile while there is no review associated with John Smith's profile). The display reviews field 1310 displays ‘Yes’ in the first row, ‘Yes’ in the second row and ‘No’ in the third row of the display reviews field column 1310 (e.g., the reviews associated with Aziza Eatery's profile and St. Smith Church's profile are selected for display in the display view 402).

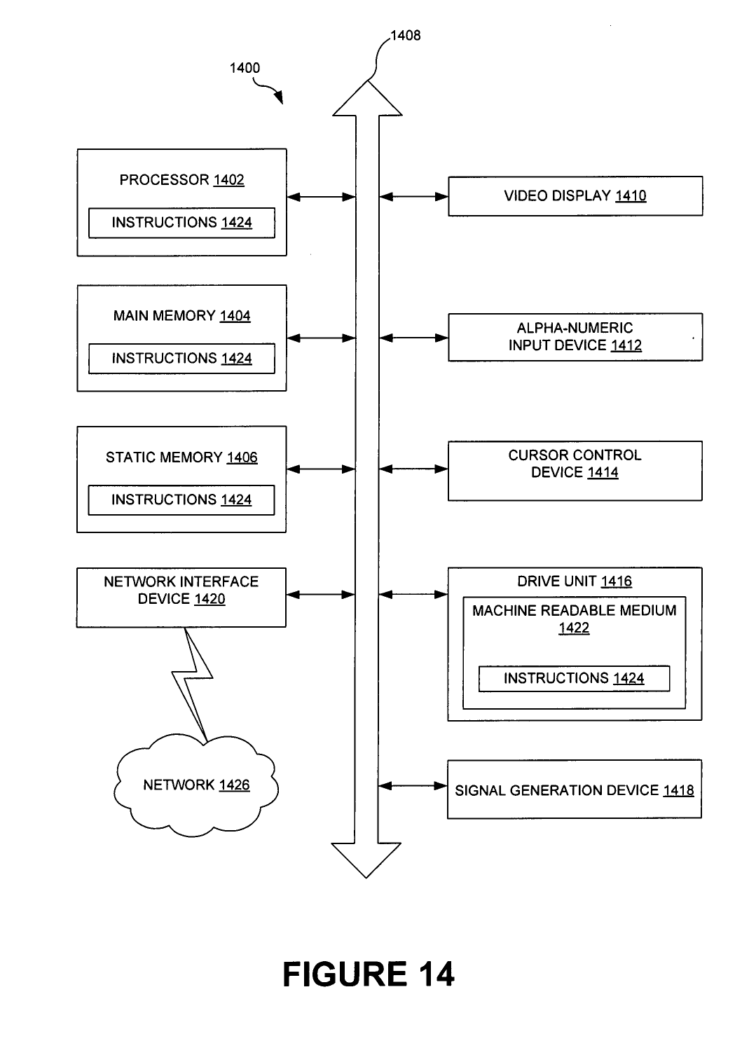

FIG. 14 is a diagrammatic system view 1400 of a data processing system in which any of the embodiments disclosed herein may be performed, according to one embodiment. Particularly, the diagrammatic system view 1400 of FIG. 14 illustrates a processor 1402, a main memory 1404, a static memory 1406, a bus 1408, a video display 1410, an alpha-numeric input device 1412, a cursor control device 1414, a drive unit 1416, a signal generation device 1418, a network interface device 1420, a machine readable medium 1422, instructions 1424 and a network 1426, according to one embodiment.

The diagrammatic system view 1400 may indicate a personal computer and/or the data processing system in which one or more operations disclosed herein are performed. The processor 1402 may be a microprocessor, a state machine, an application specific integrated circuit, a field programmable gate array, etc. (e.g., Intel® Pentium® processor). The main memory 1404 may be a dynamic random access memory and/or a primary memory of a computer system.

The static memory 1406 may be a hard drive, a flash drive, and/or other memory information associated with the data processing system. The bus 1408 may be an interconnection between various circuits and/or structures of the data processing system. The video display 1410 may provide graphical representation of information on the data processing system. The alpha-numeric input device 1412 may be a keypad, a keyboard and/or any other input device of text (e.g., a special device to aid the physically handicapped).

The cursor control device 1414 may be a pointing device such as a mouse. The drive unit 1416 may be the hard drive, a storage system, and/or other longer term storage subsystem. The signal generation device 1418 may be a bios and/or a functional operating system of the data processing system. The network interface device 1420 may be a device that performs interface functions such as code conversion, protocol conversion and/or buffering required for communication to and from the network 1426. The machine readable medium 1422 may provide instructions on which any of the methods disclosed herein may be performed. The instructions 1424 may provide source code and/or data code to the processor 1402 to enable any one or more operations disclosed herein.

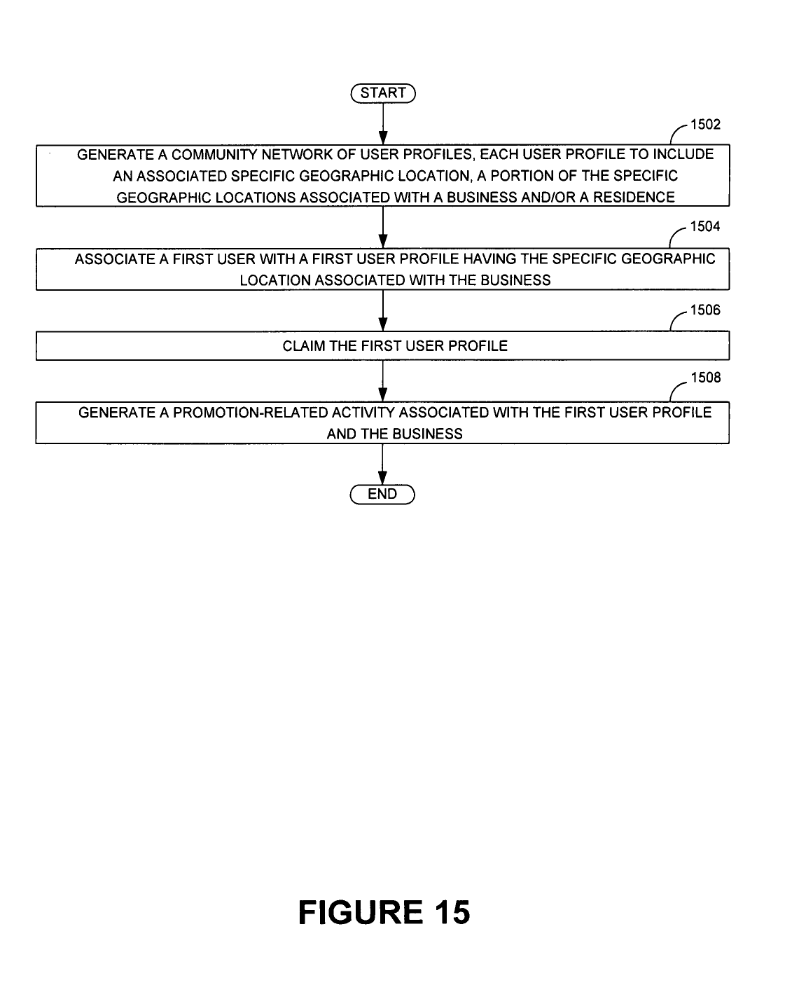

FIG. 15 is a process flow of generating a promotion-related activity associated with a business and a user profile 204, according to one embodiment. In operation 1502, a community network (e.g., the community network 200 of FIG. 2) of user profiles (e.g., the user profiles 204 of FIG. 2) may be generated (e.g., using a the community network module 106 of FIG. 1), each user profile 204 to include an associated specific geographic location (e.g., the specific geographic location 206 of FIG. 2), a portion of the specific geographic locations 206 associated with a business and/or a residence. In operation 1504, a first user may be associated with a first user profile (e.g., the first user profile 204A of FIG. 4) having a specific geographic location 206 associated with the business. In operation 1506, the first user profile 204A may be claimed (e.g., using the claim module 110 of FIG. 1). In operation 1508, a promotion-related activity associated with the first user profile 204A and the business may be generated (e.g., using the transaction module 114 of FIG. 1).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and/or electrical circuits (e.g., application specific integrated (ASIC) circuitry, Digital Signal Processor (DSP) circuitry, etc.).

For example, the community network module 106, the map module 108, the claim module 110, the display module 112, the transaction module 114, the additional modules 116, the review control module 302, the payment module 302A, the website module 304, the advertisement module 306, the poll module 308, the sponsorship module 310, the wiki profile module 312 and other modules from FIG. 1-15 may be enabled using a community network circuit, a map circuit, a claim circuit, a display circuit, a transaction circuit, additional circuits, a review control circuit, a payment circuit, a website circuit, an advertisement circuit, a poll circuit, a sponsorship circuit, a wiki profile circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
generating a community network of user profiles, each user profile of the user profiles to include an associated specific geographic location, at least a portion of the specific geographic locations associated with at least one of a business and a residence;
associating a first user with a first user profile of the user profiles having a specific geographic location associated with the business;
claiming the first user profile of the user profiles; and
generating a promotion-related activity associated with the first user profile of the user profiles and the business.

2. The method of claim 1, wherein the claiming the first user profile of the user profiles includes verifying at least one of an email address, a business license, and a utility bill.

3. The method of claim 1, wherein the promotion-related activity includes at least one of:
selectively displaying at least one review of reviews associated with the business;
permitting selective display of at least one review of the reviews associated with the business upon a payment transaction;
incorporating a website associated with the business into the first user profile of the user profiles;
generating an online transaction associated with the business;
generating an advertisement associated with the first user profile of the user profiles;
displaying the first user profile of the user profiles in conjunction with a wiki profile;
generating content associated with the wiki profile;
generating a poll associated with the business;
generating a list of groups seeking sponsorship; and
displaying the first user profile of the user profiles in conjunction with a list of groups sponsored by the business.

4. The method of claim 3, wherein the website includes at least one of a web page and a link associated with the business.

5. The method of claim 3, wherein the online transaction includes:
reserving at least one of a product and a service associated with the business;
ordering at least one of the product and the service associated with the business; and
generating an online payment transaction associated with the business.

6. The method of claim 3, wherein the generating an advertisement includes at least one of:
displaying an online advertisement;
generating a printed publication;
generating a printed publication from the online advertisement;
generating an advertisement based on a predetermined criterion associated with a second user profile of the user profiles; and
generating a display view of the first user profile of the user profiles and the advertisement, the display view associated with the second user profile of the user profiles.

7. The method of claim 3, wherein the printed publication comprises at least one of a coupon, a flyer, and a post card.

8. The method of claim 1 in a form of a machine-readable medium embodying a set of instructions that, when executed by a machine, causes the machine to perform the method of claim 1.

9. A system, comprising:
a geographic community environment;
a community network module of the geographic community environment, the community network module to include user profiles, each user profile of the user profiles to include an associated specific geographic location, at least a portion of the specific geographic locations associated with at least one of a business and a residence;
a map module of the geographic community environment to include map data which serve as a basis to render a three-dimensional map view which identifies at least some physical structures having specific geographic locations;
a claim module of the geographic community environment to claim a first user profile of the user profiles having a specific geographic location associated with a business;
a display module of the geographic community environment to generate a display view of the three-dimensional map view embodied by the community network and the first user profile of the user profiles represented at a location in the three-dimensional map view associated with the specific geographic location of the first user profile of the user profiles; and
a transaction module of the geographic community environment to generate a promotion-related activity associated with the first user profile of the user profiles and the business.

10. The system of claim 9, further comprising a review control module of the geographic community environment to control the display of at least one review of reviews associated with the business.

11. The system of claim 10, further comprising a payment module of the geographic community environment to permit selective control over display of the at least one review of the reviews associated with the business upon a payment transaction.

12. The system of claim 9, further comprising a website module of the geographic community environment to incorporate a website associated with the business into the first user profile of the user profiles, wherein the website includes a display of at least one of a web page and a link associated with the business.

13. The system of claim 12, wherein the website module comprises at least one of:
a reservation transaction to generate a reservation associated with at least one of a product and a service associated with the business;
an order transaction to order at least one of the product and the service associated with the business; and
an online payment transaction associated with the business.

14. The system of claim 9, further comprising an advertisement module of the geographic community environment to generate an advertisement associated with the first user profile of the user profiles.

15. The system of claim 14, wherein the advertisement comprises at least one of:
an online advertisement display;
a printed publication; and
a printed publication generated from an online advertisement.

16. The system of claim 14, wherein the printed publication comprises at least one a coupon, a flyer, and a post card.

17. The system of claim 14, wherein the advertisement module further comprises an advertisement, based on a predetermined criterion associated with a second user profile of the user profiles, displayed in conjunction with the first user profile of the user profiles.

18. The system of claim 9, further comprising a poll module of the geographic community environment to generate a poll associated with the business.

19. The system of claim 9, further comprising a sponsorship module of the geographic community environment to generate a list of groups seeking sponsorship and to display the first user profile of the user profiles in conjunction with a list of groups sponsored by the business.

20. The system of claim 9, further comprising a wiki profile module of the geographic community environment to generate in a display view, at least one of a wiki profile associated with a user profile of the user profiles and content associated with the wiki profile.

21. The system of claim 9, wherein the claim module further verifies a proof of business ownership.

22. The system of claim 21, wherein the proof of business ownership includes at least one of an email address, a business license, and a utility bill.

23. A geographic community environment, comprising:
a first instruction set to enable a community network, to include a user database to include user profiles, the community network associated with map data, in which the community network is associated with specific geographic locations identifiable in the map data and at least a portion of the specific geographic locations associated with at least one of a business and a residence;
a second instruction set integrated with the first instruction set to claim a user profile of the user profiles having a specific geographic location associated with a business; and
a third instruction set integrated with the first instruction set and the second instruction set to generate a promotion-related activity associated with the user profile of the user profiles and the business.

24. The geographic community environment of claim 23, further comprising:
a fourth instruction set integrated with the first instruction set, the second instruction set and the third instruction set to selectively display in conjunction with the user profile of the user profiles at least one review of reviews associated with the business.
